(19) United States
(12) Patent Application Publication
(10) Pub. No.: US 2021/0287321 A1
(43) Pub. Date: Sep. 16, 2021

(54) TRANSPORT COORDINATION SYSTEM

(71) Applicant: Skoot Ride.Com Ltd., Surrey (GB)

(72) Inventors: Greg Gormley, Surrey (GB); Mark Stringer, Surrey (GB)

(73) Assignee: Skoot Ride.Com Ltd., Surrey (GB)

(21) Appl. No.: 16/819,880

(22) Filed: Mar. 16, 2020

(51) Int. Cl. G06Q 50/30; G06Q 10/02; G01C 21/34

(52) U.S. Cl. CPC G06Q 50/30; G01C 21/343; G01C 21/3438; G06Q 10/02

(57) ABSTRACT

A computer-implemented method of connecting user equipments, UEs, to coordinate a transport request is disclosed. The method comprises receiving a message from a first UE comprising a first user identification, ID, a destination and a specified future time; sending a message to a plurality of second UEs comprising the first user ID, the destination and the specified future time; receiving a response from a subset of the plurality of second UEs indicating an acceptance; receiving or determining at least one pick up location; determining a set of second UEs corresponding to a set of proposed riders from the subset of the plurality of second UEs; sending a trip confirmation message to the set of second UEs corresponding to the set of proposed riders; calculating a route from a driver starting location to the destination by way of the at least one pick up location; and sending the calculated route to the first UE.

### FIELD OF INVENTION

The present application relates to transport coordination.

### BACKGROUND

Arranging transport by a computer-implemented application for traditional taxi-type manners of ride-sharing is well known. Examples of such applications include the Uber and Lyft systems. Such arrangement of transport, by a computer-implemented application, does not provide solutions for peer-to-peer ride-sharing or transport coordination. Peer-to-peer ride-sharing or transport coordination relies on traditional arrangements, such as a journey requestor having to specifically call a peer to ask for transport to a location. Such traditional approaches lack efficiency in coordinating transport.

There is a need for improved transport coordination in a peer-to-peer ride-sharing. An object of the invention is to address this need, amongst others.

### SUMMARY OF INVENTION

According to an aspect of the present invention there is provided a computer-implemented method of connecting user equipments (UEs) to coordinate a transport request, the method comprising: receiving at a server, a message from a first user equipment, UE, comprising a first user identification, ID, a destination and a specified future time; sending, from the server, a message to a plurality of second UEs comprising the first user ID, the destination and the specified future time; receiving, at the server, a response from a subset of the plurality of second UEs indicating an acceptance; receiving or determining, at the server, at least one pick up location; determining, at the server, a set of second UEs corresponding to a set of proposed riders from the subset of the plurality of second UEs; sending, from the server, a trip confirmation message to the set of second UEs corresponding to the set of proposed riders; calculating, at the server, a route from a driver starting location to the destination by way of the at least one pick up location; and sending, from the server, the calculated route to the first UE.

In this way, a transportation request can be successfully facilitated between a driver and a number of riders. This method can be administered in a highly efficient manner at the server, managing communications between the driver and a potentially large number of second UEs. This technique has found great utility in identifying otherwise unknown shared interests between groups interested in travelling to the same location, thereby reducing traffic on the roads and offering the potential to reduce the environmental impact of travel.

The UEs are generally cellular telephones and the messages are preferably sent from the UEs to the server and from the server to the UEs via an app. Messages can be sent via telecommunication networks or via the internet, as appropriate.

The method may comprise sending, from the server, the calculated route to the set of second UEs corresponding to the set of proposed riders. In this way, the second UEs can review the calculated route, and can monitor the positions of all travellers in real-time.

The message received at the server from the first UE preferably includes a number of available seats. The message from the first UE also preferably includes a trip title, and may include a graphic or image that is associated with the trip. If the first UE does not specify a number of available seats then the server may use a default number, such as four, or a different number depending on the stored settings relating to a vehicle associated with the first UE.

The pick up location may be received at the server from the first UE. In this way, the first UE can propose a (single) pick up location at which all of the riders will gather. The proposed pick up location may be mandatory or optional, depending on system settings.

A plurality of pick up locations may be received from the set of second UEs corresponding to the set of proposed riders. In this way, the riders can each propose a pick up location, which may correspond to their home address. The driver can then collect each of the riders. The pick up locations may be a negotiable parameter between riders and drivers to ensure efficient routing.

One or more pick up locations may also determined at the server based on stored parameters related to the first UE and the set of second UEs corresponding to the set of proposed riders. In this way, the server can determine one or more pick up locations that are mutually most convenient for the driver and the riders. This can improve efficiency by avoiding the need for potentially tortuous negotiations between individuals.

The method may involve receiving, at the server, a selection of the plurality of second UEs that are to be sent the message comprising the first user ID, the destination and the specified future time. The first UE can therefore identify the plurality of second UEs with whom they would prefer to travel. The invitation can be sent first to these second UEs, and subsequently to other second UEs, depending on whether the initial invitations are accepted. The method may involve sending, from the server, a list of available second UEs to the first UE for the first UE to make a selection.

The method may comprise filtering the list of available second UEs based on one or more parameters determined by the first UE. In one arrangement the first UE can specify preferred filters to be applied to second UEs, before they select their preferred travel companions. The filter may be pre-set, or it may be specified by the first UE in a message to the server. In one example, the filter may specify preferred locations, a preferred gender and/or a preferred age range, although, of course, a variety of other similar filters would be possible. This can allow the first UE better flexibility in terms of their choices, and can decrease the risks inherent in shared travel.

In some circumstances the method may involve receiving, at the server, a response from a second UE of the plurality of second UEs indicating a refusal, and subsequently sending, from the server, a message to at least one further second UEs comprising the first user ID, the destination and the specified future time. This can allow the invitation to be extended to an additional second UE, in the event that the initial invitation is refused by an original invitees. This can allow the first UE to re-issue invitations to further second UEs to ensure that the available seats are allocated in time for the trip.

The method may involve sending, from the server, before the trip confirmation message is sent, a message to the first UE confirming the set of proposed riders from the subset of the plurality of second UEs, and receiving, at the server, a message from the first UE rejecting at least one of the proposed riders. In this way, the transport can be coordinated more quickly and more efficiently in the case where the driver does not accept a proposed rider. In some examples, this may occur because the proposed rider suggests an inconvenient pickup location.

The method may also involve sending, from the server, the position of the first UE to the set of second UEs corresponding to the set of proposed riders, and sending, from the server, to the first UE the positions of the second UEs in the set of second UEs corresponding to the set of proposed riders. This can allow each participating UE to display a map showing the location of the first UE and all of the relevant second UEs. Each participant in the trip can therefore be appraised of the real-time location of every other participant so that they can monitor progress. This can help allow participants to adjust where there are differences between their actual positions and pick up locations.

The method may also involve determining, at the server, the expected times at which the first UE is due to arrive at each pick up location. These expected times can then be sent from the server to the first UE and the relevant second UEs and displayed on their user interfaces.

The method may also comprise accessing, at the first UE, a telephone number of a contact stored in a contact list at the first UE; hashing, at the first UE, the telephone number of the contact to create a hashed contact telephone number; and sending, by the first UE, the hashed contact telephone number to the server.

In this way the telephone information of users can be securely stored at the server.

The server preferably stores a plurality of user profiles, each user profile comprising a hashed user telephone number corresponding to a UE associated with the user profile. The server can therefore match hashed contact numbers to determine users who are connected with one another, while maintaining confidentiality with respect to telephone numbers.

According to another aspect of the invention there is provided a server computer comprising one or more processors configured to: receive a message from a first user equipment, UE, comprising a first user identification, ID, a destination and a specified future time; identify a plurality of second UEs which are associated with the first UE; send a message to the plurality of second UEs comprising the first user ID, the destination and the specified future time; receive a response from a subset of the plurality of second UEs indicating an acceptance; receive or determine, at the server, at least one pick up location; determine a set of second UEs corresponding to a set of proposed riders from the subset of the plurality of second UEs; send a trip confirmation message to the set of second UEs corresponding to the set of proposed riders; calculate a route from a driver starting location to the destination by way of the at least one pick up location; and send the calculated route to the first UE.

According to yet another aspect of the invention there is provided a non-transitory computer readable medium comprising executable instructions which, when executed by a server, cause the server to carry out steps comprising: receiving at a server, a message from a first user equipment, UE, comprising a first user identification, ID, a destination and a specified future time; sending, from the server, a message to a plurality of second UEs comprising the first user ID, the destination and the specified future time; receiving, at the server, a response from a subset of the plurality of second UEs indicating an acceptance; receiving or determining, at the server, at least one pick up location; determining, at the server, a set of second UEs corresponding to a set of proposed riders from the subset of the plurality of second UEs; sending, from the server, a trip confirmation message to the set of second UEs corresponding to the set of proposed riders; calculating, at the server, a route from a driver starting location to the destination by way of the at least one pick up location; and sending, from the server, the calculated route to the first UE.

### BRIEF DESCRIPTION OF THE DRAWINGS

Embodiments of the invention are now described, by way of example, with reference to the drawings in which:

FIG. 1 is a flow diagram of the operational steps involved in registering a user of the transport coordination system;

FIG. 2 is a block diagram of a user profile of the transport coordination system;

FIG. 3 is a flow diagram of the operational steps involved in creating a group within the transport coordination system;

FIG. 4 is a block diagram of a group profile of the transport coordination system;

FIG. 5 is a flow diagram of a first example of the operational steps of interactions between entities in the transport coordination system;

FIG. 6 is a flow diagram of a second example the operational steps of interactions between entities in the transport coordination system;

FIG. 7 is a block diagram of architecture of the transport coordination system; and

FIG. 8 is a flow diagram of a process for connecting UEs to coordinate a transport request.

### DETAILED DESCRIPTION

A transport coordination, or ride-sharing, system and method are provided in which a user of a transport coordination or ride-sharing application loaded on a first device can schedule a journey to a destination and invite a second user of the ride sharing application loaded on a second device. The second user can accept the invitation to participate in the scheduled journey. The user of the first device can be considered a ‘driver’, and the user of the second device can be considered a ‘passenger’.

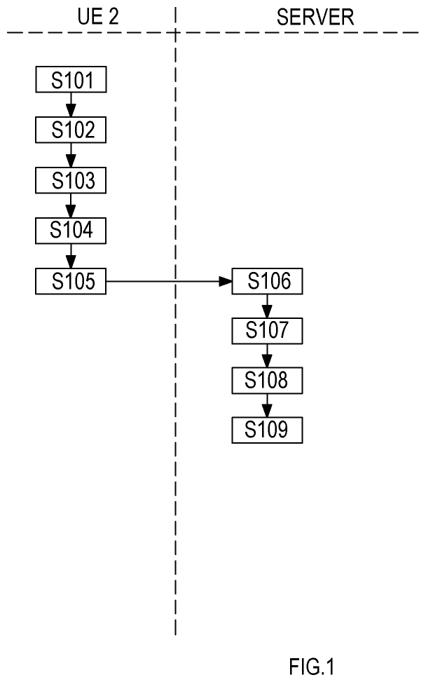

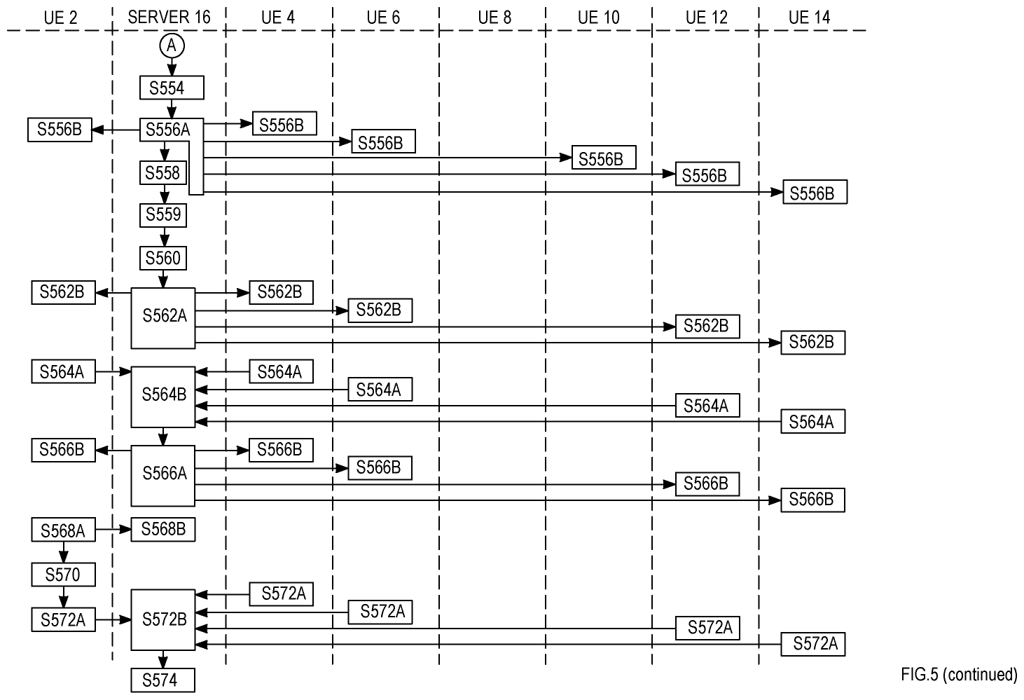

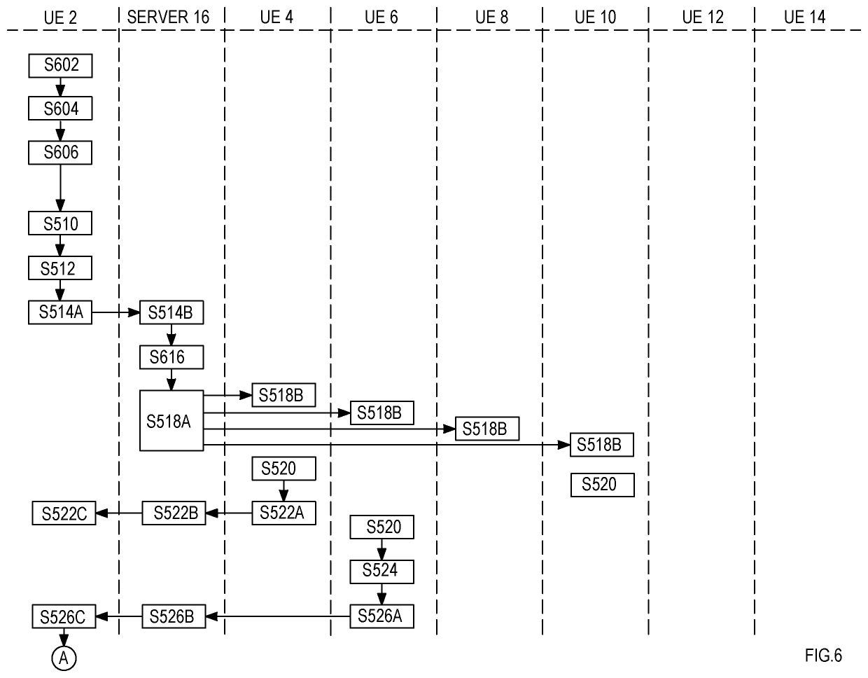

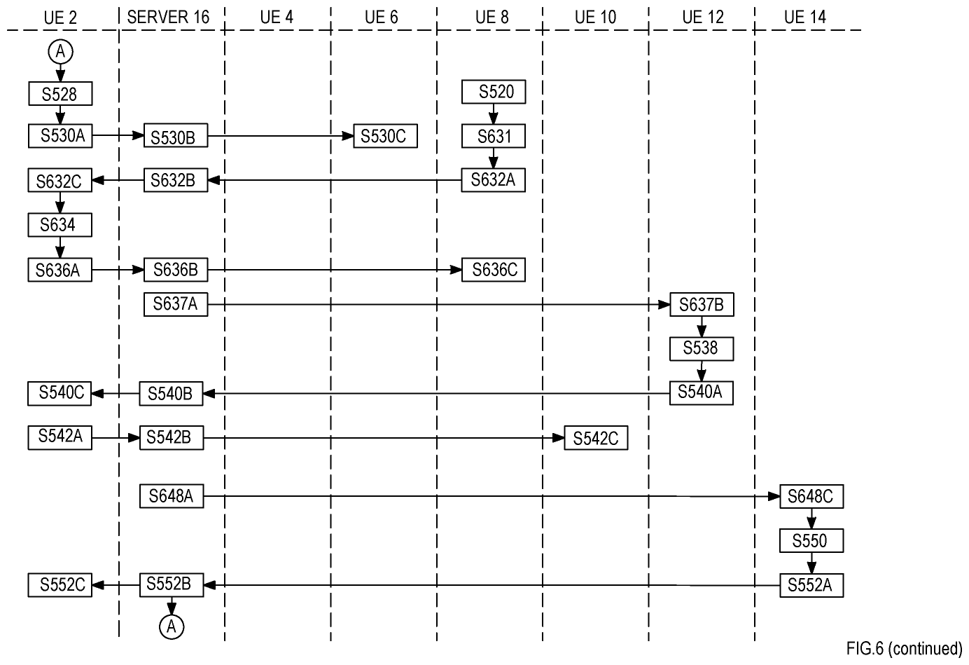

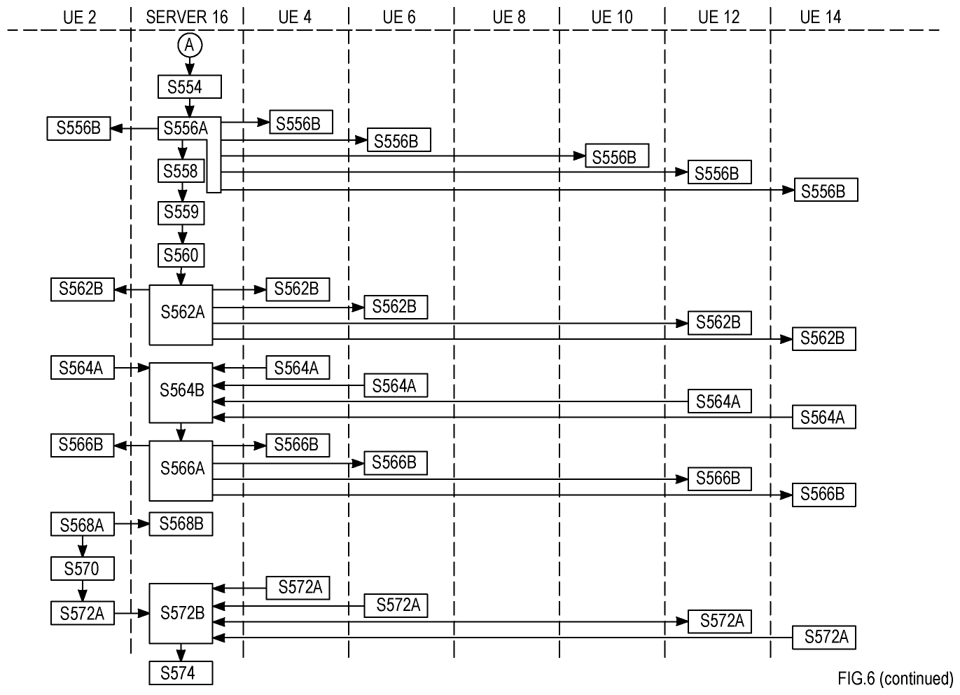

FIG. 1 shows a flow diagram of the operational steps involved in registering a user of the transport coordination system. In examples, this can occur before coordinating transport as subsequently described with reference to FIGS. 5 and 6.

A user installs the transport coordination application on a device or UE (user equipment), such as a smartphone device. At step S101, when the user opens the application for the first time they are presented with a registration interface. In an example the registration interface requests the user to enter personal information such as a telephone number and name. In some examples other personal information, such as contact information including home and/or work address, username, payment information and any other suitable information may also be entered at this stage. In other examples it may be entered later. In some examples, a user may register and login using a connected third party application, particularly a social application, such as SnapChat. In addition to registering as a requestor or passenger, a user can also register as a driver. When registering as a driver, the user may be prompted to enter a vehicle registration number, and/or scan a copy of their driver's license which is then verified. A user profile of a user who can act as a driver can include an attribute indicating that the user is a driver. The application also asks for device permissions to receive push notifications. At step S102 the user enters the requisite personal information. The application also requests access to the address book of the UE, which the user can grant.

At step S103, the application hashes the user's telephone number (i.e. the telephone number of the UE). At step S104, the application also hashes the contact telephone numbers of the user's contacts from the address book. In an example the application uses MD5 hashing, although any other suitable type of hashing may instead be used. The application can store the hashed contact telephone numbers in a hash table at the UE. In some examples, other information such as a username may be hashed and stored in the hash table. At step S105, the application sends the hashed user telephone number, as well as the other personal information, to a server that hosts the transport coordination system. The application also sends the hashed contact telephone numbers and home address, if a home address has been provided, to the server.

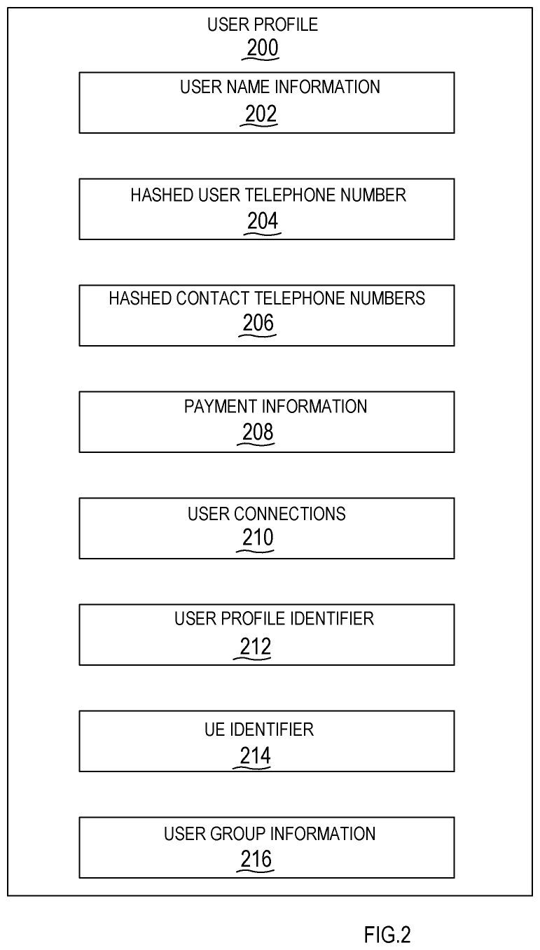

At step S106, the server receives the user's personal information, the hashed user telephone number, the hashed home address, and hashed contact telephone numbers, and stores this information in a user profile of the user at the server. FIG. 2 shows an exemplary block diagram of a user profile 200 stored at the server, including the user's name information 202, the plain and the hashed user telephone number 204, the hashed contact telephone numbers 206, payment information 208, the user's connections 210 to other users of the transport coordination system, a user profile identifier 212 such as a unique reference number associated with the user profile, a UE identifier 214 of the UE associated with the user profile 200 and the user's group membership information 216. In some examples, the payment information is tokenized and the server stores tokens issued by a partner payment service provider; payments can then be requested with these tokens. The user profile can also include a driver attribute for users who are verified as drivers within the system. User profiles with the driver attribute can be considered as ‘driver profiles’. In some examples, only users with the driver attribute can act as drivers, whereas all users can act as passengers. The skilled person will readily understand that any other suitable user information can be stored in the user profile 200.

At step S107, the server matches the hashed contact telephone numbers with matching hashed user telephone numbers of other user profiles registered with the transport coordination service. That is, contacts of the user who are already registered with the transport coordination service, and whose respective hashed user telephone numbers are already stored at the server in their own respective profiles, are matched with the user by way of the matching hashed contact telephone numbers.

At step S108, the server connects the user's profile with the profiles of the other users with a hashed user telephone number matching one of the user's hashed contact telephone numbers 206, thereby establishing a connection between the users of the transport coordination system such that the users are connections within the system. These connections can be considered first-level connections.

Any unidentified hashed contact telephone numbers, that is hashed contact telephone numbers that do not match a hashed user telephone number in an existing user profile, are stored at the server in a ‘waiting list’ associated with the user profile. In this way, when a new user joins the system, the new user's hashed user telephone number may be matched against the hashed contact telephone number in the existing user's ‘waiting list’. In this way the new user and the existing user can be associated as connections in the system. The hashed contact telephone number is then deleted from the ‘waiting list’.

At step S109, the server may determine the respective first-level connections of each of the first-level connections associated with the user's profile and connect these to the user's profile as second-level connections.

In some examples, the application may detect a change to the user's address book at the UE. For example, the user may have added a new contact to their address book. When this occurs the application hashes this new contact telephone number and sends it to the server where it is stored in the user's profile as a hashed contact telephone number. If this hashed contact telephone number matches an existing hashed user telephone number of another user profile stored at the server, a connection is established between the users such that the users are connections within the system. In this way, if the user adds a new contact to the address book of the UE and the new contact is also a user of the transport coordination system, the user and the new contact become connections within the transport coordination system. Within the application, a list of friends (i.e. the user's connections within the system) is pulled from the server, this allows the friend list to be refreshed each time the user accesses the friend list within the application.

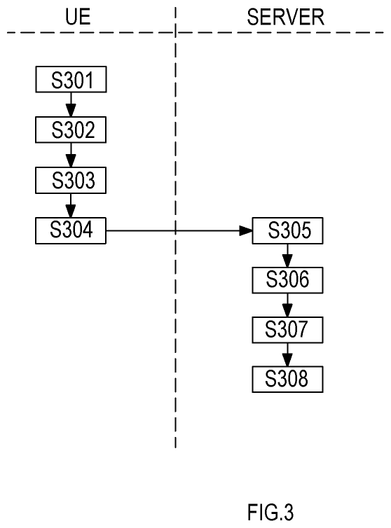

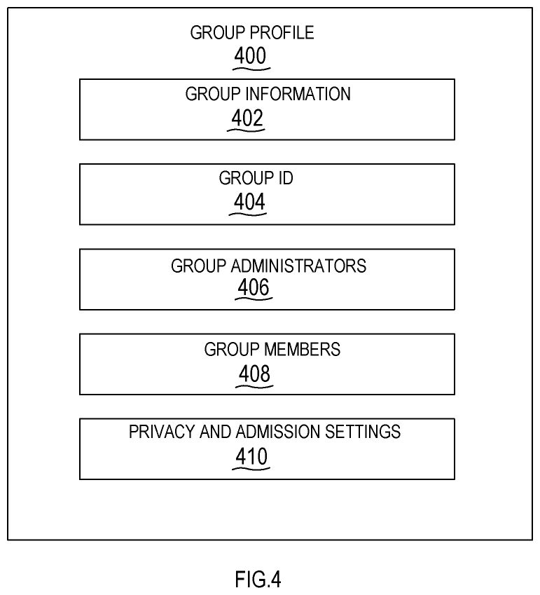

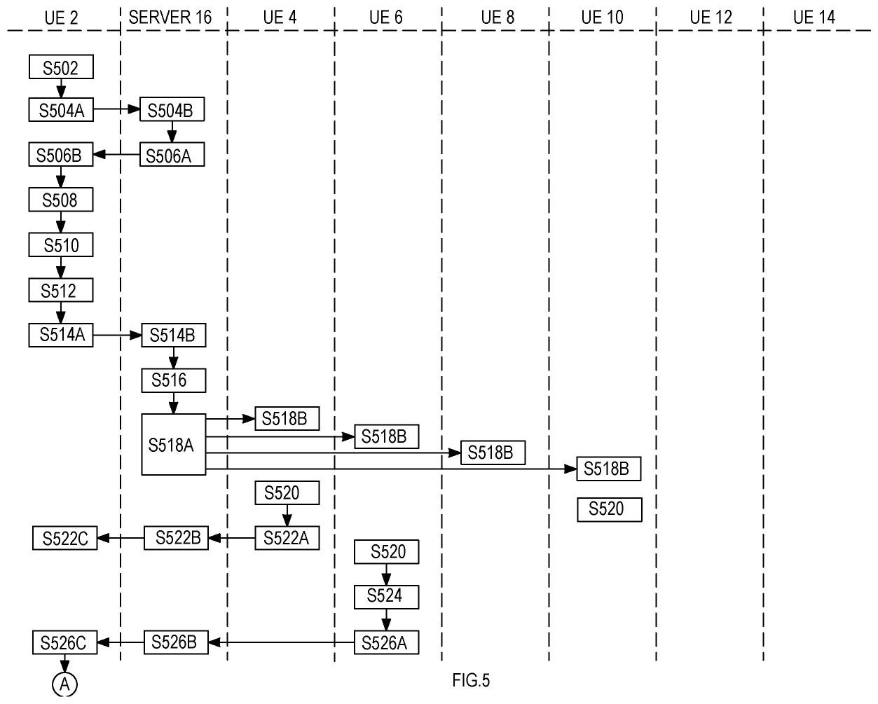

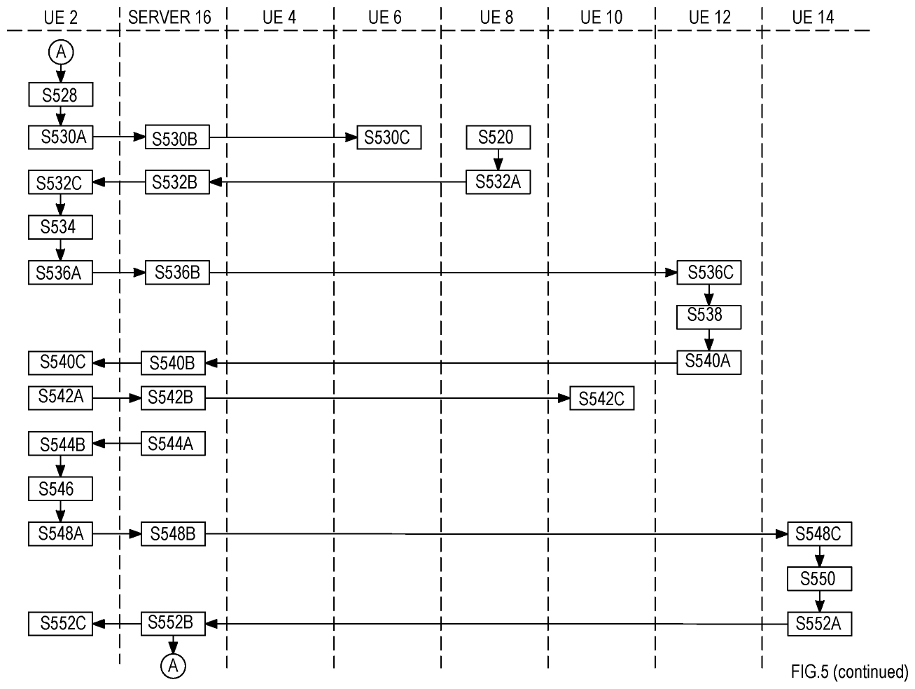

In some examples, users of the transport coordination system can create, join and administrate ‘groups’ of user profiles via interfaces of the transport coordination application loaded onto their UEs. FIG. 3 shows a flow diagram of the operational steps involved in creating a group. Each group created in the transport coordination system may be stored in the server as a group profile 400. FIG. 4 shows an exemplary block diagram of a group profile 400 stored at the server, including: the group's information 402; a unique group identifier, group ID 404; a list of the user profile identifiers of the group's administrators, group admins 406; a list of the user profile identifiers of members of the group, group members 408; and privacy and admission settings 410.

At step S301, the user navigates to a group creation interface of the transport coordination application loaded onto the UE which prompts the user to enter a group name. In some examples, the user may be prompted to enter optional information such as a profile image, a description of the group, or a geographical area associated with the group.

The user who creates the group may be considered the ‘group administrator’. In some examples, group administrators have additional group privileges which may allow them to edit group information, accept or decline users who have requested to join the group, assign a public or private setting to the group, or assign an admission policy for the group.

At step S302, the group administrator may select other users to invite to the group from a list of their first and second level connections. In some examples, the user may be able to select an option on an interface of the UE to invite other users to the group as additional group administrators or as members which do not have administrator privileges.

At step S303, the group administrator is prompted to select a privacy setting and an admission policy for the group via an interface of the application. The group administrator can select a private setting, in which the group is not shown to all users of the transport coordination application through a group browsing interface. Alternatively, the group administrator can select a public setting, in which all users of the transport coordination application can view the group information of the public group and send a request to join the group via the group browsing interface. Additionally, the group administrator may select a closed admission policy in which a group administrator is required to accept a user request to join a group before the requesting user can join the group. Alternatively, the group administrator may select an open admission policy, in which an administrator is not required to accept user requests to join the group. In this latter case, a request sent by a user to join a group automatically adds the user to the group. In some examples, a public or private group setting may not be implemented. In which case, groups may be joined only by way of invitation from a group member or group administrator.

At step S304, the application sends the group name and any additional information provided by the group administrator, a list of users to be invited to the group, and the selected privacy and admission settings for the group to the server that hosts the transport coordination system.

At step S305, the server receives the information sent by the application in step S304. The server then creates a group profile 400 for the group and stores the group information 402 such as the group name and description, the user identifier of the group administrator, and the privacy and admission settings 410 in the group profile 400. At step S306 the group is assigned a unique group identification number 404 which is stored in the group profile 400. The group identification number 404 is also stored in the user profile 200 associated with the group administrator. The group identification number 404 may also be stored in the user profile 200 of each member of the group. A list of group administrators of the group is maintained at the server in the group profile 400. This list is updated whenever the server receives a message indicating that a new user has accepted an invitation to join the group as an administrator. Similarly, the user profiles of the new group administrators are updated to record which groups they are administrators of.

At step S307 the server sends an invite message to a plurality of UEs associated with the users selected by the group administrator to be invited to the group. The server may determine which UEs correspond to the users selected by the group administrator by matching the user profile identifiers selected by the group administrators to the corresponding UE identifier. The users associated with the plurality of UEs can accept the invite message through an interface of the application loaded onto the UE. The UEs can then send a response message to the server which comprises an acceptance indicator, indicating acceptance of the invitation. The UE identifier 214 and the user profile identifier 212 associated with each user who accepts the invitation are added to the group members 408 of the group profile 400. Alternatively or additionally, they are also added to the group administrators 406 of the group profile 400 if that user has been invited to join the group as an administrator. Alternatively, the users can decline the invitation to join the group by selecting a decline option provided on an interface of the UE. In this latter case, the user is not added to the list of group members 408 or the list of group admins 406 within the group profile 400.

In some examples, if the group administrator has selected a public privacy setting for the group, then step S308 occurs at which the group is made visible to all users of the transport coordination application via a group browsing interface. Otherwise, the group is not made visible to all users of the transport coordination application. The group browsing interface enables users to browse public group profiles stored on the server and view the group information with each public group. Users can then select a group they wish to join, and send a request to join the group using the group browsing interface. The request is then forwarded to the group administrators, via the server, who can accept or decline the request.

FIG. 5 shows a flow diagram of the operational steps of interactions between entities in the system involved in a first user (i.e. the driver) of a first UE 2 in the transport coordination system scheduling a journey to a destination. The operational steps are shown between entities of the system when users (i.e. passengers) of a second UE 4, a third UE 6, a fourth UE 8, a fifth UE 10, a sixth UE 12, and a seventh UE 14 in the transport coordination system accept, decline or do not respond to an invitation to participate in the journey to the scheduled destination. Each of the UEs has the transport coordination application loaded thereon.

At step S502 the transport coordination application loaded on a first UE 2, that is a UE of the driver who wishes to schedule a journey, presents a user interface on a display of the first UE 2. The driver can enter a scheduled destination, a trip name, a journey date and time which is in the future, whether or not the journey should be associated with a group (i.e. the group should be a ‘group journey’), and a number of available seats. The number of available seats corresponds to the number of available seats in a vehicle which the driver wishes to provide to users (i.e. passengers) of the transport coordination application to participate in the journey undertaken with the vehicle. In some examples, a journey can be scheduled 5 minutes in advance of the journey time, giving the ability for spontaneous journey planning. The skilled person would understand that other appropriate minimum time periods may be implemented. In some examples, the number of available seats may be set to four by default. In some examples, additional trip information may be provided at this step, such as a trip description or an image file. The journey time can be entered as an arrival time or a departure time by selecting an ‘arrival time’ option or a ‘departure time’ option presented on the user interface. The journey time option selected can be later used to calculate an optimal route, a leaving time or an arrival time. In the example of FIG. 5, the user does not choose to associate the journey with a group.

At step S504A the first UE 2 generates and sends a connections list request message to a server 16, requesting the list of all the user connections 210 of the driver. This list can be considered the driver's ‘connections list’. Filters may be selected by the driver via an interface of the ride sharing application loaded onto the first UE 2, and included in the connections list request message. Examples of filters can include a preference for ‘favourite’ friends, a filter for connections above or below a certain age, a filter for only female or male connections, a filter for connections only within a certain distance, or a filter for only first or second level connections. The skilled person will readily understand that any other suitable filters can also be used. In an example, the filters may be applied to show a number of favourite friends as well as a number of geographically closest friends. The filters are applied as defined by the user within the application. One or more filters may be applied.

At step S504B the server receives the connections list request message. The server 16 can determine the filters included in the connections list request message and apply these selected filters to the user connections 210 in the driver's profile 200. The connections list can then be generated from the user connections 210 in the driver's user profile 200 based upon the filters provided in the connections list request message.

At step S506A the server 16 generates the connections list which comprises user profile identifiers 212 corresponding to users from the driver's first and second level connections in the driver's user profile 200, according to any selected filters. The server 16 then sends list to the first UE 2. The first UE 2 receives the connections list at step S506B.

At step S508, the application loaded on the first UE 2 presents the driver with the connections list, and the driver selects a number of connections from the connections list to invite, via an interface of the application. In an example, the presented interface may be on a touchscreen interface at which the user of the first UE 2 can select their preferred connections by pressing a name, image or other information associated with the connection displayed on the touchscreen. The selected connections can be considered ‘invitees’. In some examples, a number of invitees may be chosen up to the number of available seats. In the example of FIG. 5, the driver initially selects a second user which is associated with a second UE 4, a third user which is associated with a third UE 6, a fourth user which is associated with a fourth UE 8 and a fifth user which is associated with a fifth UE 10. In other examples, the system may be configured to allow the driver to select more users to invite than there are available seats. In such embodiments, the users who first to respond to the invite and are first accepted by the driver to participate may be allocated an available seat on the trip.

At step S510, the transport coordination application prompts the driver to select a pickup location option for the scheduled journey. The driver can make a selection from: ‘mandatory pickup location’ or ‘suggested pickup location’. If the driver selects the ‘mandatory pickup location’ option, then the invitees will not later be prompted to provide a pickup location. In such examples, the invitees are required to accept the suggested pickup location in order to participate in the journey. If the driver selects the ‘suggested pickup location’ option, then the invitees will later be prompted to either accept the suggested pickup location, or reject the suggested pickup location. If the suggested pickup location is rejected by an invitee, the invitee can then be prompted to provide a new pickup location. In the example of FIG. 5, the driver selects the ‘suggested pickup location’ option.

At step S512, the driver provides a suggested pickup location. The pickup location may be selected via an interface on the application which comprises a map. The suggested pickup location may be the driver's home address by default. In some examples, if the driver has selected the ‘suggested pickup location’ option, the transport coordination application may present the driver with a further option to not provide a suggested pickup location. If the driver elects not to provide a suggested pickup location, the invitees would then later be required to suggest an alternative pickup location in order to accept the journey invitation. In such cases, the driver may be additionally required to provide a starting location, at which the driver intends to begin the journey.

At step S514A, the first UE 2 generates a journey creation message. The journey creation message comprises all of the information input by the driver in steps S502-S512, such as: the scheduled destination; the journey name; the journey date and time; the list of invitees selected from the driver's connections list, which comprises a list of user profile identifiers 212 corresponding to the invitees; the selected pickup option; the pickup location, if a pickup location has been suggested (or demanded); any additional information provided in step S502, and the user profile identifier 212 of the driver.

The journey creation message may comprise one or more GPS locations associated with the selected scheduled destination and, in relevant examples, the suggested pickup location. Any other suitable location information in place of GPS locations can be used. It will be understood that whenever GPS location and navigation are described throughout the description of all embodiments in the present disclosure, any other suitable type of location information and navigation can be used as alternatives, for example other GNSS systems, regional navigation systems, a coordinate system, and cellular location amongst others.

At step S514B, the server 16 receives the journey creation message.

At step S516, the server 16 determines the UE associated with each of the connections, or invitees, selected by the driver. This is done by matching the user profile identifiers 212 in the journey creation message to the corresponding UE identifiers 214 stored at the server 16. In this example, the server 16 identifies the UEs corresponding to the invitees as the second UE 4, third UE 6, fourth UE 8, and fifth UE 10.

At step S518A, the server 16 generates and sends a journey invite message to the second UE 4, the third UE 6, the fourth UE 8 and the fifth UE 10. The journey invite message comprises the journey name; the journey date and time; any additional information provided in step S502; the selected pickup option; the pickup location, if a pickup location has been suggested; and the user profile identifier 212 of the user profile associated with the first UE 2 (i.e. the user profile identifier of the driver). In some embodiments, a list of user profile identifiers 212 of the invitees selected by the driver may also be included in the journey invite message which is sent to the second UE 4, third UE 6, fourth UE 8, and fifth UE 10. The skilled person would understand that other information could be included in the journey invite message. At step S518B the second UE 4, third UE 6, fourth UE 8, and fifth UE 10 receive the journey invite message.

At step S520, the applications loaded on the second UE 4, third UE 6, fourth UE 8, and fifth UE 10, each present the user of the UE with a journey invite interface on a display of the UE. The journey invite interface displays the information received in the journey invite message, such as the scheduled destination, the user name information 202 of the driver, the journey date and time; the selected pickup option; the pickup location, if a pickup location has been suggested; and any additional information provided in step S502. The journey invite interface of the application loaded on each UE prompts each user to accept or decline the invite by selecting an ‘accept journey’ option, or a ‘decline journey’ option. In the example of FIG. 5, if the accept journey option is selected, the journey invite interface then prompts the corresponding user to accept or decline the suggested pickup location provided by the driver. The application presents an ‘accept pickup location’ option, or a ‘decline pickup location’ option, which the corresponding user can select by, for example, tapping on a touchscreen display of the UE.

In the example of FIG. 5, at step S520, the second user selects the ‘accept journey’ option and the ‘accept pickup location’ option. At step S522A, the second UE 4 generates a journey invitation response message comprising a journey acceptance indicator which indicates that the second user has accepted the journey invitation. The journey response message additionally comprises a pickup location acceptance indicator which indicates that the second user accepts the suggested pickup location. The journey invitation response message is then sent to the server 16. At step S522B, the server 16 receives the journey invitation response message. The server 16 then determines the indicators included in the message, and keeps a record of the indicators received at the server 16. The server 16 then forwards the invitation response notification message to the first UE 2 which is associated with the driver. At step S522C, the message is received at the first UE 2 and a notification is displayed on an interface of the first UE 2 which indicates to the driver that the second user has accepted the journey invitation and accepted the suggested pickup location.

The server 16 is to be understood to automatically determine and store the result of any indicators included in a message sent to the server 16. In this way, the server 16 can record which users have provided journey acceptance indictors, and can thus determine that those users are ‘booked in’, or have been ‘allocated an available seat’ on the scheduled journey.

In the example of FIG. 5, at step S520, the third user selects the ‘accept journey invite’ and the ‘decline suggested pickup location’ options. At step S524, the third UE 6 then presents the third user with a pickup location interface which allows the third user to suggest an alternative pickup location. The third user then enters a new pickup location using an interface of the application loaded onto the third UE 6. In some examples, the interface may comprise a map.

At step S526A, the third UE 6 generates a journey invitation response message comprising a journey acceptance indicator, and a pickup location rejection indicator which indicates that the third user has rejected the suggested pickup location. The journey invitation response message further comprises the newly suggested alternative pickup location. The journey response message is then sent to the server 16 which receives the message at step S526B. At step S526B, the server 16 then forwards the journey response message to the first UE 2 which is associated with the driver. The invitation response message is received at the first UE 2 at step S526C.

At step S528, the application loaded on the first UE 2 determines that the journey response message sent by the third UE 6 comprises a pickup location rejection indicator. As a result, the first UE 2 presents the driver with an interface which prompts the driver to accept or decline the new pickup location by selecting an ‘accept new pickup location’ option, or a ‘decline new pickup location’ option. The interface may display the suggested alternative pickup location on a map. In the example of FIG. 5, the driver accepts the new pickup location. In other examples, the driver may reject the new pickup location. In the case where the driver rejects the new pickup location, the transport coordination system may generate messages and provide interfaces which allow the driver and the third user to continually re-suggest new pickup locations until a pickup location is accepted by both the driver and the third user. In other embodiments, rejecting the new pickup location may retract the invite to the third user, and cause the server 16 to provide the driver with a connections list so that other connections of the driver can be invited to replace the third user.

At step S530A, the first UE 2 generates a pickup location response message comprising an indicator which indicates that the driver has accepted the alternative pickup location. The new pickup location response message is then sent by the first UE 2 to the server 16. The message is received at the server 16 at step S530B and forwarded to the third UE 6. At step S530C, the message is received by the third UE 6. The third UE 6 determines that the message received comprises an indicator which indicates that the first user has accepted the alternative pickup location. The third UE 6 then generates and displays a notification on an interface of the application loaded onto the third UE 6 which indicates to the third user that the driver has accepted the new pickup location.

In the example of FIG. 5, at step S520, the fourth user selects the ‘decline journey’ option. In response, at step S532A, the fourth UE 8 generates a journey invitation response message comprising a decline journey indicator which indicates that the fourth user has declined the journey invite message. The journey invitation response message is then sent to the server 16. At step S532B, the server 16 receives the journey invitation response message. The server 16 then forwards the invitation response notification message to the first UE 2 which is associated with the driver. The server 16 may also add to the journey invitation response message the user profile identifiers 212 of the first and second level connections of the driver, so that the driver can later pick a new connection to invite. At step S532C, the message is received at the first UE 2 and a notification is displayed on an interface of the first UE 2 which indicates that the fourth user has declined the journey invitation.

Step S534 occurs in response to the first UE 2 determining that the journey invitation response message received from the third UE 6 comprises a journey decline indicator. The application loaded onto the first UE 2 presents the driver with an interface which allows the driver to select a new connection to invite to participate in the journey. In the example of FIG. 5, the driver selects a sixth user corresponding to a sixth UE 12. In other examples, the driver may elect not to select a new connection to invite, and undertake the scheduled journey with an unfilled seat.

At step S536A, the first UE 2 generates a new invitee message comprising the user profile identifier 212 associated with the sixth user, and sends the message to the server 16. The server 16 receives the new invitee message at step S536B and generates a journey invite message, as described with reference to step S518A. The server 16 matches the user profile identifier of the sixth user selected by the driver to the UE identifier 214 of the sixth UE 12 and sends the journey invite message to the sixth UE 12. The journey invite message is received at the sixth UE 12 at step S536C.

At step S538, the application loaded on the sixth UE 12 presents the user of the sixth UE with a journey invite interface on a display of the UE, as described with reference to step S520. The journey invite interface prompts the sixth user to accept or decline the invite. In the example of FIG. 5, the journey invite interface also prompts the user to accept or decline the suggested pickup location provided by the driver. In this example, the sixth user selects the ‘accept journey’ and the ‘accept suggested pickup location’ option.

At steps S540A, S540B, and S540C, a journey invitation response message is generated at the sixth UE 12 and sent to the first UE 2, via the server 16, as described in reference to steps S522A, S522B, and S522C, respectively. At step S540C, the message is received at the first UE 2 and a notification is displayed on an interface of the first UE 2 which indicates that the sixth user has accepted the journey invitation and accepted the suggested pickup location.

In the example of FIG. 5, at step S520, the fifth user does not respond to the journey invite message. In examples, this may be occur because the fifth UE 10 is switched off, does not have a suitable connection to receive the journey invite message, or because the fifth user does not select an option to accept or decline the journey invite message.

At step S542A, the driver navigates to an interface of the transport coordination application loaded onto the first UE 2 and initiates a reminder. In response, the first UE 2 generates a reminder message comprising an indicator that prompts the recipient application of the reminder message to provide a reminder to respond to the journey invite message. The first UE 2 then sends the reminder message to the server 16. The reminder message is received at the server 16 at step S542B and forwarded onto the fifth UE 10. The fifth UE 10 receives the reminder message at step S542C. In the example of FIG. 5, the fifth user still does not provide a response to the journey invite message. In some examples, the driver may be able to send additional reminders to the invitees who have not provided a response to the journey invite message. In some examples, reminders may be issued by the server 16 automatically.

At step S544A, which occurs at a predetermined time period before the scheduled journey time, the server 16 determines the number of unfilled available seats. This can be calculated by subtracting the number of journey invitation response messages comprising invitation acceptance indicators that have been sent through the server 16 from the number of available seats provided by the driver in the journey creation message. The server 16 generates a no response message comprising an indicator that prompts the recipient application to notify the driver that the fifth user has still not responded to the journey invite message. The server 16 also adds to the no response message the user profile identifiers 212 of the first and second level connections of the driver before sending the no response message to the first UE 2. At step S554B, the no response message is received at the first UE 2 and a notification is displayed on an interface of the first UE 2 that indicates that the fifth user has still not responded to the journey invitation.

Preferably, the predetermined time period before the scheduled journey time at which step S544A occurs is 24 hours. The skilled person would understand that other time periods may be used alternatively or in addition. In some example embodiments, the transport coordination system may allow the driver to select the predetermined time period via a settings interface of the application loaded onto the first UE 2.

At step S546, the application loaded on the first UE 2 presents the driver with an interface that allows the driver to select a new connection to invite to participate in the journey, to replace the unresponsive fifth user. In the example of FIG. 5, the driver selects a seventh user which is associated with a seventh UE 14. In other examples, the driver may elect not to select a new connection to invite and proceed to complete the journey only with the second user, the third user and the sixth user corresponding to the second UE 2, the third UE 8 and the sixth UE 12, respectively.

In some examples, the driver can send additional journey invitation messages to a plurality of users associated respectively with a plurality of UEs, in addition to the seventh UE 14, in order to try and ensure that the remaining available seat is filled. In such examples, the user of a UE of the plurality of additional UEs who first responds to the journey invite message with a journey acceptance indicator, and who is first accepted by the driver, may be allocated the remaining available seat. For the sake of clarity of the diagrams, the specific operational steps involved in this process are not shown in FIG. 5.

Once the driver selects the seventh user to invite to participate in the journey, steps S548A-S552C proceed as described with reference to steps S536A-S540C, respectively, in which the sixth user receives and accepts a journey invite message. In summary, steps S548A-S552C proceed as follows: the first UE 2 generates a journey invite message and forwards the message to the seventh UE 14 which is associated with the seventh user, via the server 16. The seventh user selects the ‘accept journey invite’ and the ‘accept suggested pickup location’ option via an interface of the application loaded onto the seventh UE 14. The seventh UE 14 generates and sends, via the server 16, a journey response message to the first UE 2 comprising an indicator which indicates that the seventh user has accepted the journey invitation and the suggested pickup location.

The skilled person would understand steps S520 to S552C may occur in other orders. In general the order will be determined by the order in which the first user (i.e. the driver), the second user, the third user, the fourth user, the fifth user, the sixth user and the seventh user respond (or do not respond) to the plurality of invitations and messages described so far in this application.

At step S554, the server 16 checks if the number of messages comprising outstanding journey acceptance indicators sent via the server 16 equals the number of available seats, as provided in the journey creation message. The server determines that the number of outstanding journey acceptance indicators equals the number of available seats. Thus, the server 16 determines the journey is ‘closed’, and that there are no more available seats waiting to be allocated to a user. In other examples, this check may occur each time after a message containing a journey acceptance indicator is received by the server 16 so that the server 16 can determine when the journey is closed.

Step S556A occurs in response to the server 16 determining that the journey is closed, as described in step S554. At step S556A, the server 16 generates a journey closed message comprising an indicator which indicates that there are no more available seats on the trip. The server 16 sends the journey closed message to the first UE 2 corresponding to the driver, and to all of the UEs corresponding to users which have either accepted the journey invite message or have not responded to the journey invite message. In the example of FIG. 5, the server 16 sends the journey closed message to the second UE 4, the third UE 6, the fifth UE 10, the sixth UE 12, and the seventh UE 14. The UEs receive the journey closed message at step S556B. The fourth user is not sent a journey closed message because the fourth user declined the journey invite message at step S520.

The server 16 can add additional information to the journey closed message depending on the intended recipient UE. The journey closed message sent to the driver additionally includes the user profile identifiers 212 of all of the users associated with the UEs which provided a journey acceptance indicator to the server 16. The journey closed message sent to the second UE 4, the third UE 6, the sixth UE 12 and the seventh UE 14 may additionally comprise an indicator which prompts the applications loaded on the corresponding UEs to provide a notification informing the user that they have been booked in on the journey. The journey closed message sent to the fifth UE 10 may comprise an indicator which prompts the application loaded on the fifth UE 10 to indicate via the interface that they have not been booked in on the journey because they failed to respond in time. In some examples, the users booked in on the journey are also provided with the user profile identifiers 212 of the other users who are booked in on the journey. This can be implemented by the server 16, which can add the appropriate user profile identifiers 212 to the appropriate journey closed messages.

At step S558, the server 16 calculates the optimal route between the pickup locations and the destination. In the example of FIG. 5, the server 16 calculates the optimal route that sequentially connects the pickup location initially suggested by the driver, the pickup location suggested by the third user, and the destination. The server 16 also determines the distance of the optimal route using GPS information of each location. In other examples where the driver does not suggest a pickup location, the route may be calculated from a starting location provided by the driver to each pickup location, and then subsequently to the destination location.

Once the server 16 has calculated the optimal route for the journey, the server 16 calculates a first, a second, a third, and a fourth estimated cost for the journey at step S559. The first estimated cost can be based on a first unit price per mile multiplied by the number of miles the server 16 expects the driver to travel during the journey, based on the provided GPS location information. The second estimated cost can be based on the first estimated cost divided the number of users participating in the journey, including the driver. In an example, the second estimated cost may be the price which is charged to each passenger user. The third estimated cost can be based on a second unit price per mile multiplied by the number of miles the server 16 expects the driver to have travel during the journey, also based on the provided GPS location information. The fourth estimated cost can be based on the third estimated cost divided the number of users participating in the journey, including the driver. The fourth estimated cost may be the price which is paid to the driver by each passenger user. In such an example, the first unit price per mile may be higher than the second unit price per mile, thereby making the first estimated cost higher than the third estimated cost. In some examples, the estimated costs can later be used to calculate a final cost. In other examples, the estimated costs may be used as final costs which are charged to the passengers and paid to the driver. In some examples, the server 16 sends the estimated costs in a message to each UE participating in the journey, so that the UE can display the estimated cost to the user in a notification. The estimated costs may be pre-authorised with a payment service provider at this step, before the journey is scheduled to take place, using payment information provided by each user during registration. In this way, the payment from each passenger is assured. In some examples, the passengers may be charged and the driver may be paid, using the estimated costs, at this step.

The journey time provided by the driver in step S502 can be entered as an arrival time or a departure time by selecting an ‘arrival time’ option or a ‘departure time’ option, provided at step S502. The driver can select the arrival time option if the driver wishes to arrive at the destination by a specific time. In which case, an arrival time indicator is included in the journey creation message that indicates this choice of the driver. Otherwise, the driver can select the departure time option if the driver wishes to depart from the first location in the optimal route at a specific time. In which case, a departure time indicator is included in the journey creation message that indicates this choice of the driver.

At step S560, if the driver has selected the arrival time option, then the server 16 calculates a leaving time based on the calculated optimal route. The leaving time indicates at what time the driver should leave the first location in the route in order to reach the destination by the arrival time. In this example, the first location is the suggested pickup location suggested by the driver. The server 16 additionally calculates the time at which the driver is expected to arrive at any subsequent pickup locations along the route. In the example of FIG. 5, the only subsequent pickup location is the alternative pickup location that was suggested by the third user in step S524. If, instead, the driver has selected the departure time option, then the server 16 calculates an expected arrival time based on the provided departure time. Additionally, the server 16 calculates the times at which the driver is expected to arrive at each pickup location based on the provided departure time.

In this way, the transport coordination application can very efficiently coordinate the transport and travel of multiple users. By flexibly calculating the departure or arrival times, and by providing the times at which the users should be at their corresponding pickup locations, the system is both easy to use and encourages users to be ready to be picked up at the appropriate time.

At step S562A, the server 16 generates a route itinerary message comprising: the calculated optimal route; any expected arrival and departure times; and the time at which each user participating in the journey should be at the appropriate pickup location. The server 16 then sends the route itinerary message to the UEs associated with the passengers booked in on the trip and to the UE associated with the driver. In this example, the route itinerary message is sent to the first UE 2, the second UE 4, the third UE 6, the sixth UE 12, and the seventh UE 14. At step S562B, the UEs receive the route itinerary message.

Once the UEs have received the route itinerary message, the user of each UE can navigate to an interface of the application loaded onto their respective UE which displays the route itinerary on a display of their UE. This functionality may, for example, be provided at any time before the end of the journey. The route itinerary may be presented on an interface comprising a map.

Step S564A occurs at a predetermined time period before the departure time at which the journey is scheduled to begin. In some examples, this time period may be about 10 minutes. At step S564A, each UE participating in the journey relays its own GPS position information to the server 16. This GPS position information is transmitted constantly or at predetermined regular intervals such that a live feed of the GPS position of the each UE participating in the journey is sent to the server 16. At step S564B, the server receives the GPS position information from each UE participating in the journey.

At step S566A, the server 16 relays the feed of GPS position information of each UE participating in the journey to all UEs participating in the journey. In this way, each user can monitor the position of the other users during the journey, in order to better coordinate the pickup of each passenger. At step S566B each UE participating in the journey receives the feed and presents, on the display of the UE, an interface comprising a map which indicates the calculated route and the feed of GPS position information of all UEs participating in the journey.

Steps S564A-S5666B may occur continuously throughout the journey so that the location feed can be accessed by any user in the journey at any time during the journey. This enables the users to track the progress of the vehicle along the optimal route.

Optionally, at step S566B, the first UE 2 receives the relayed feed of GPS position information of the first UE 2 from the server 16 to guide the user of the first UE 2 to each pickup location along the route. The first UE 2 can present, on a display, a map with navigational guidance to the location of the next pickup location.

In the example of FIG. 5, the second user, the sixth user and the seventh user have accepted the suggested pickup location provided by the driver. At step S568A the first UE 2 can determine that the GPS position of the first UE 2 and the second UE 4 are coincident or within a predetermined distance of one another. Upon this determination, the first UE 2 generates and sends a collection notification message to the server 16 to indicate that the user of the second UE 4 has now reached the user of the first UE 2 (the driver) and has been collected for the journey. The first UE 2 can determine in the same way that the sixth and the seventh users have been collected, and also relay this information to the server 16. In this way, collection of the passengers by the driver can be automatically determined without a specific user input. Alternatively or additionally, the application loaded on the first UE 2 can display an interactive option on the display of the first UE 2 which, when selected, generates and sends the collection notification message to the server 16. In this way, the server 16 can be reliably notified that the driver has collected the passenger. In other examples, the interactive option may be displayed on the second UE 4, the sixth UE 12 or the seventh UE 14, in combination with or alternatively to the interactive option displayed on the first UE 2. The server 16 receives the collection notification message sent by the first UE 2 at step S568B, and determines that the second user, the sixth user and the seventh user have been collected by the driver.

Following the determination in step S568A that collection has occurred, the application loaded on the first UE 2 presents the driver with information relating to the route to the next pickup location, at step S570. In other examples, step S570 may occur at each UE participating in the journey in response to the server 16 notifying each UE that it is aware that the collection has occurred. In such cases this information may also presented, by the applications loaded thereon, to the users of the second UE 4, the third UE 6, the sixth UE 12 and the seventh UE 14.

The information relating to the journey may comprise an estimated arrival time, an elapsed journey time, a remaining journey time, an elapsed distance from the pickup location, a remaining distance to the destination, GPS navigation on a map to the destination, or any other suitable information.

Steps S564A-S570 may repeat until the sixth user has been collected by the driver. The driver and the passengers can then proceed to travel towards the destination.

At step S572A, the first UE 2 determines that the current GPS position of the first UE 2 is at or within a predetermined distance, such as 50 metres, of the GPS location of the destination; that is, the first UE 2 determines that the destination has been reached. The application loaded on the first UE 2 then presents a journey completion notification on the display of the first UE 2. Alternatively or additionally, the first UE 2 may present an interactive option on the display which, when selected, causes the first UE 2 to determine at step S572A that the destination has been reached. Following the determination that the destination has been reached, the first UE 2 generates a journey complete message to send to the server 16. In the example of FIG. 5, this step occurs simultaneously at the second UE 4, the third UE 6, the sixth UE 12, and the seventh UE 14. Each UE then sends the journey complete message to the server 16. The server 16 receives the journey complete messages at step S572B and determines that the trip is complete.

In some examples, only one of the UEs (that is, either the first UE 2, the second UE 4, the third UE 6, the sixth UE 12 or the seventh UE 14) generates and sends the journey complete message to the server 16. For example, only the first UE 2 generates and sends the journey complete message to server 16 for the server 16 to determine that the journey is complete. Alternatively, only the passenger UEs (that is, the second UE 4, the third UE 6, the sixth UE 12 or the seventh UE 14) generate and send the journey complete message to server 16 for the server 16 to determine that the journey is complete.

In other examples, all of the UEs participating in the journey generate and send the journey complete message to the server 16. That is, all UEs need to report that they have reached the destination for the server 16 to determine that the journey is complete at step S572B.

At step S574, the server 16 uses the GPS location information feed provided by the first UE 2 in step S562A to determine the distance travelled by the driver over the course of the journey. The server 16 then calculates a first, second, third and fourth final cost for the journey.

In an example, a first final cost, a second final cost, a third final cost and a fourth final cost can be calculated based upon two parts (part A, part B), and further based upon the estimated costs calculated at step S559.

Part A is the calculated or estimated optimal route distance from the starting location of the journey to each subsequent location in the journey. In the example of FIG. 5, the starting location is the initial pickup location suggested by the driver in the journey creation message at step S510. The subsequent locations are the new pickup location, suggested by the third user at step S524, and the destination. The server 16 has already determined the distance of the optimal route at step S558.

Part B is the actual measured elapsed journey distance from when the driver starts the journey (at step S568A, in the example of FIG. 5) until the destination is reached (at step S572B, in the example of FIG. 5). The actual elapsed journey distance can be determined by the server 16 using the GPS location messages provided by the first UE 2 at step S564A and provided continually throughout the journey. In this way, any deviations due to traffic issues, additional passenger pickups, or other diversions during the journey are accounted for.

The first final cost can be calculated as (A+B) multiplied by the first unit price per mile. The second final cost can be the amount charged to each passenger, and can be calculated by dividing the first final cost by the number of users participating in the journey, including the driver. The third final cost can be calculated as (A+B) multiplied by the second unit price per mile. The fourth final cost can be the amount paid to the driver by each passenger, and can be calculated by dividing the third final cost by the number of users participating in the journey, including the driver.

In some examples, the passengers may be pre-charged the second estimated cost when the transport is arranged, and then charged the difference between the second estimated cost and the second final cost when the journey is complete. In this way, any discrepancy between the estimated cost and the final estimated cost due to extra distance travelled is accounted for. Additionally, the passengers are discouraged from not participating in the journey because an initial sum has already been charged. In some examples, the final costs may not be calculated and instead the users may only be charged or paid costs which were estimated at step S559.

At step S574, the server 16 charges the passengers according to the method described above. The journey is completed at step S574.

In some examples, the driver can send additional journey invite messages to a plurality of users associated respectively with a plurality of UEs, in addition to the second UE 4, the third UE 6, the fourth UE 8 and the fifth UE 10. In such examples, the UEs which receive journey invite messages which first respond to the journey invite message with a message comprising a journey acceptance indicator may be allocated an available seat automatically by the server 16. The remaining invitees may then be notified that they have not responded to the journey invite message in time. In some examples, the server 16 may only automatically allocate an available seat to a user if the invitation response message sent from the corresponding UE does not comprise an indicator indicating that a new pickup location has been suggested in the message. In practice, this feature can be implemented at step S508 by enabling the user to select more connections to invite than there are available seats.

In some embodiments, the application loaded on the first UE 2 presents the driver with an option to create a recurring journey. This may occur, for example, at step S502. If the driver selects this option, an interface of the application may prompt the user to select from additional options related to recurring journeys. Examples of such additional options are frequency options (e.g. schedule the journey monthly, or weekly) and connection choice options (e.g. invite the same connections each journey or choose new connections each journey). The skilled person would understand that other options may be implemented alternatively or in addition. The journey creation message may then comprise indicators which indicate the choices of the user in respect of the recurring journey options. The server 16 may send out journey invite messages automatically at a scheduled recurring date before each recurring journey is scheduled to take place. Alternatively, the server 16 may send a message to the first UE 2 at a scheduled recurring date before each recurring journey to prompt the user to select users to invite to participate in the journey.

In the example of FIG. 5, messages sent between the UEs (i.e. UEs 2, 4, 6, 8, 10, 12, 14) correspond via the server 16. The skilled person would understand that in other embodiments, the UEs may send messages directly between UEs using mobile communications channels or via an internet connection. In such cases, the UEs may send messages to the server 16, in addition to the messages sent between the UEs of the system, in order to update the server 16 that an indicator has been received. The skilled person would understand that calculation steps, such as step S558 in which the optimal journey route is calculated, may equally be carried out by an application loaded onto a UE of the system, such as the first UE 2. Equally, determination steps, such as step S532B in which the server 16 determines that the fourth user has declined the journey invite, may be carried out by the application loaded onto the first UE 2.

FIG. 6 shows a flow diagram of the operational steps of interactions between entities in the system involved in a first user (i.e. the driver) of a first UE 2 in the transport coordination system scheduling a journey to a destination using ‘group’ functionality. The operational steps are shown between entities of the system when users (i.e. passengers) of a second UE 4, a third UE 6, a fourth UE 8, a fifth UE 10, a sixth UE 12, and a seventh UE 14 in the transport coordination system accept or do not respond to an invitation to participate in the journey to the scheduled destination. Each of the UEs has the transport coordination application loaded thereon. In the example of FIG. 6, each of the users of the first UE 2, second UE 4, third UE 6, fourth UE 8, fifth UE 10, sixth UE 12, and the seventh UE 14 have previously accepted invitations to join a user ‘group’, as described with reference to FIGS. 3 and 4.

At step S602 the transport coordination application loaded on a first UE 2, that is a UE of the driver who wishes to schedule a journey, presents a user interface on a display of the first UE 2. The driver can enter a scheduled destination, a trip name, a journey date and time which is in the future, and a number of available seats and whether or not the journey should be associated with a group (i.e. the group should be a ‘group journey’). In some examples, a journey can only be scheduled a minimum of 5 minutes in advance of the journey time. The skilled person would understand that other appropriate minimum time periods may be implemented. In some examples, the number of available seats may be set to four by default. In some examples, additional trip information may be provided at this step, such as a trip description or an image file. The journey time can be entered as an arrival time or a departure time by selecting an ‘arrival time’ option or a ‘departure time’ option presented on the user interface. The journey time option selected can be later used to calculate an optimal route.

In the example of FIG. 6, the driver has selected an option indicating that the journey should be associated with a group, i.e. the driver wishes to schedule a ‘group journey’. The application loaded on the first UE 2 may present the driver with a list of groups of which the driver is a member. In the example of FIG. 6, the group name 402 and group ID 404 of each group of which the driver is a member may be stored on the first UE 2. In other examples, the group name 402 and group ID 404 may be retrieved by the first UE 2 from the group profile 200 of the driver stored on the server 16, by querying the server 16. The driver then selects the group name 402 the driver wishes to associate the journey with.

Step S604 may occur in response to the first UE 2 determining that the driver has selected a group for the group journey. At step S604, the driver may be prompted to select from a number of invite options. For example, the driver may presented with an ‘invite all’ option on the interface of the application. If the driver selects this option, the journey creation message may comprise an invite all indicator, indicating to the server 16 that the driver wishes to automatically send a journey invite to all members of the group which meet the criteria of the selected filters. Alternatively, the driver may select an ‘invite selection only’ option. If the driver selects this option, the journey creation message may comprise an invite selection only indicator indicating that the driver wishes to manually select specific users from the group members which meet the criteria of the filters. In the example of FIG. 6, the driver selects the ‘invite all’ option.

In this way, the process of scheduling a journey can be made more efficient because the driver does not have to select specific users of the transport coordination system to invite. By using an ‘invite all’ option, the driver can instead use filters, as described below, to conveniently instruct the server 16 on which users should be invited without requiring further input from the user. This method can avoid certain operational steps because the first UE 2 does not need to request and display a connections list, and receive the choices of the driver, before sending the journey creation message.

In step S604, the application loaded on the first UE 2 prompts the driver to select from a number of filters. Filters may be selected by the driver via an interface of the application and included in the journey creation message. The filters can define which connections are retrieved from the list of group members 408 stored in the group profile 400 associated with the selected group at the server 16. Filters can also be used in order to define rules which instruct the server 16 how to determine which users of the group should be automatically invited. Examples of filters can include a preference for ‘favourite’ connections, a filter for connections above or below a certain age, a filter for only female or male connections, a filter for connections whose home addresses are within a certain distance of the driver's home address, or a filter for only first or second level connections of the driver. The skilled person will readily understand that any other suitable filters can also be used.

At step S606 the application prompts the user to select from a number of filters. The driver then selects a filter for first and second level connections only, and a preferential filter for group members with home addresses geographically closest to the driver's home address. In the example of FIG. 6, because the ‘invite all’ option has been selected by the driver, the filters can later instruct the server 16 to invite members of the group who are also first and second level connections of the driver. Additionally, in this example, the driver selects a filter which indicates to the server 16 that the group members with home addresses which are geographically closest to the driver's home address should be preferentially invited. In other examples, the driver may select a filter which sets a maximum geographical distance at which a group member's home address can be from the driver's home address.

In this way, the safety of group functionality may be improved because the driver can utilise the added convenience of group functionality while still only providing transport to first and second level connections. Additionally, by providing a filter which instructs the server 16 to preferentially invite users with home addresses which are closest to the driver's home address, the efficiency of the journey is improved by encouraging a route to the destination with minimal detours from the driver's home address. In some cases, if the passengers participating in the journey live close enough to the driver, the need for additional pickups can be avoided altogether. Thus, this method can reduce emissions on the roads and help the journey participants save money on fuel.

Steps S510 and S512 in FIG. 6 correspond to steps S510 and S512 in FIG. 5.

At step S614A the first UE 2 generates a journey creation message. The journey creation message comprises all of the information input by the driver in steps S602-S612, such as: the scheduled destination; the journey name; the journey date and time; the selected pickup option; the pickup location, if a pickup location has been suggested (or demanded); any additional information provided in step S602; a group journey indicator; the group ID 404 of the selected group; the user profile identifier 212 of the driver; an invite all indicator; and the filters selected by the driver in step S606. At step S614B, the server 16 receives the journey creation message.

At step S616, the server 16 determines that the journey creation message comprises a group journey indicator, a selection of filters, and an invite all indicator. As a result, the server 16 determines that the received filters should be applied to the group members 408 of the group corresponding to the group ID 404 provided in the journey creation message. The server 16 also determines, as a result of receiving the invite all indicator, that a journey invite message should be sent to members of the group which meet the criteria of the filters. In order to filter the group members 408 of the selected group, the server 16 may retrieve a list of all the group members 408 who are also first or second level connections of the driver. The server 16 may then systematically determine the geographical distance between the driver's home address and the home address of each group member in the list. The distances can be calculated, for example, using GPS location information of each home address. The server 16 may then sort the list of group members by the distance associated with each member. The server 16 can then select a number of members of the group corresponding to the shortest distances on the list, up to the number of available seats (in this case, four), and send journey invite messages to the UEs corresponding to those users.

In the example of FIG. 6, the server determines that the second UE 4, the third UE 6, the fourth UE 8 and the fifth UE 10 are the members of the group which are first or second level connections with the driver and have the geographically closest home addresses to the driver's home address.

Steps S518A-S530C in FIG. 6 correspond to steps S518A-S530C in FIG. 5. To summarise, in the example of FIG. 6, the second user, corresponding to the second UE 4, accepts the journey invitation and accepts the suggested pickup location. The driver is informed, via a message sent from the server 16 to the first UE 2, that the second user has accepted the journey invite. In other examples, the driver may be required to provide confirmation that the driver wishes to allocate a seat to the second user. This can improve the safety of the group functionality in cases where the filter which requires group members to be first and second level connections of the driver is not in use. Returning to the example of FIG. 6, the third user, corresponding to the third UE 6, accepts the journey invitation but suggests a new pickup location, which the driver then chooses to accept. Thus, the second user and the third user are allocated available seats in the scheduled journey.

At step S520, the fourth user corresponding to the fourth UE 8 selects the ‘accept journey invite’ and the ‘decline suggested pickup location’ options. At step S631, the fourth UE 8 determines that the fourth user has selected the ‘decline suggested pickup location’ option. The fourth UE 8 then presents the fourth user with a pickup location interface which enables the fourth user to suggest an alternative pickup location. The fourth user then enters a new pickup location into the interface. In some examples, the interface may comprise a map.

At step S632A, the fourth UE 8 generates a journey invitation response message comprising a journey acceptance indicator and a pickup location rejection indicator, which indicates that the fourth user has rejected the suggested pickup location. The journey invitation response message further comprises the newly suggested alternative pickup location. The journey response message is then sent to the server 16 which receives the message at step S632B. At step S632C, the server 16 then forwards the journey response message to the first UE 2, which is associated with the driver. The invitation response message is received at the first UE 2 at step S632C.

At step S634, the application loaded on the first UE 2 determines that the journey response message sent by the fourth UE 8 comprises a pickup location rejection indicator. As a result, the first UE 2 presents the driver with an interface which prompts the driver to accept or decline the new pickup location by selecting an ‘accept new pickup location’ option, or a ‘decline new pickup location’ option. In the example of FIG. 6, the driver selects the ‘decline new pickup location’ option. In use, this may occur if the fourth user has suggested an inconveniently distant pickup location. In the example of FIG. 6, the system is configured to automatically retract the invite to the fourth user and then invite the next group member according to the selected filters. This can reduce the amount of messages sent in the system and reduce the amount of input required from the driver to organise the journey. In other examples, the transport coordination system may generate additional messages which allow the fourth user to accept the original pickup location suggested by the driver.

At step S636A, the first UE 2 generates a pickup location response message comprising a pickup location rejection indicator which indicates that the driver has rejected the alternative pickup location. The new pickup location response message is then sent by the first UE 2 to the server 16. The message is received at the server 16 at step S636B. In the embodiment of FIG. 6, the server 16 determines that the pickup location response message comprises a pickup location rejection indicator. The server 16 then generates a retract invite message and sends this message to the fourth UE 8. The retract invite message prompts the fourth UE 8 to retract the journey invite message which was sent to the fourth UE 8 at step S518A, and thus prevent the fourth user from responding or participating in the journey. At step S636C, the fourth UE 8 receives the retract invite message. Upon receiving the retract invite message, the application loaded on the fourth UE 8 prevents the fourth user from accepting or declining the journey invite by preventing the user from accessing the journey response interface. The fourth UE may be further configured to display a notification informing the fourth user that the driver has rejected the new pickup location and that they have not been allocated an available seat.

At step S637A the server 16 automatically determines the next group member to invite using the sorting list created in step S616. The server 16 can select the UE corresponding to the user in the sorted list of group members whose home address is the next shortest distance from the driver's home address. The server 16 determines the next UE which should receive an invite message is the sixth UE 12 corresponding to the sixth user. The server 16 creates and sends a journey invite message to the sixth UE 12, which receives the message at step S637B.

Steps S538-S542C in FIG. 6 correspond to steps S538-S542C in FIG. 5.

At step S568A, which occurs at a predetermined time period before the scheduled journey time, the server 16 determines the number of unfilled available seats. This can be calculated by subtracting the number of journey invitation response messages comprising invitation acceptance indicators which have been sent through the server 16 from the number of available seats provided by the driver in the journey creation message. The server 16 determines that there is an unfilled available seat in the scheduled journey and that the fifth UE 10 has not provided a journey invite response message. The server 16 then determines the next user of the group to invite in place of the fifth user, as described in step S637A. In the example of FIG. 6, the server 16 determines that the seventh UE 14 corresponding to a seventh user has the next closest home address to the driver's home address. The server 16 then sends a journey invite message to the seventh UE 14. The seventh UE 14 receives the journey invite message at step S648C.

Steps S550-S574 in FIG. 6 correspond to steps S538-S542C in FIG. 5. In summary, the seventh user accepts the journey invite. The server 16 then determines that there are no more available seats, and determines that the journey is closed. The fifth user is informed, via a message sent from the server 16 to the fifth UE 10, that they have not responded to the invite in time and therefore have not been allocated an available seat. The journey then proceeds to completion as described with reference to FIG. 5.

The skilled person would understand that the filters used in the example of FIG. 6 may also be used in an example where group functionality is not utilised, such as the example of FIG. 5.

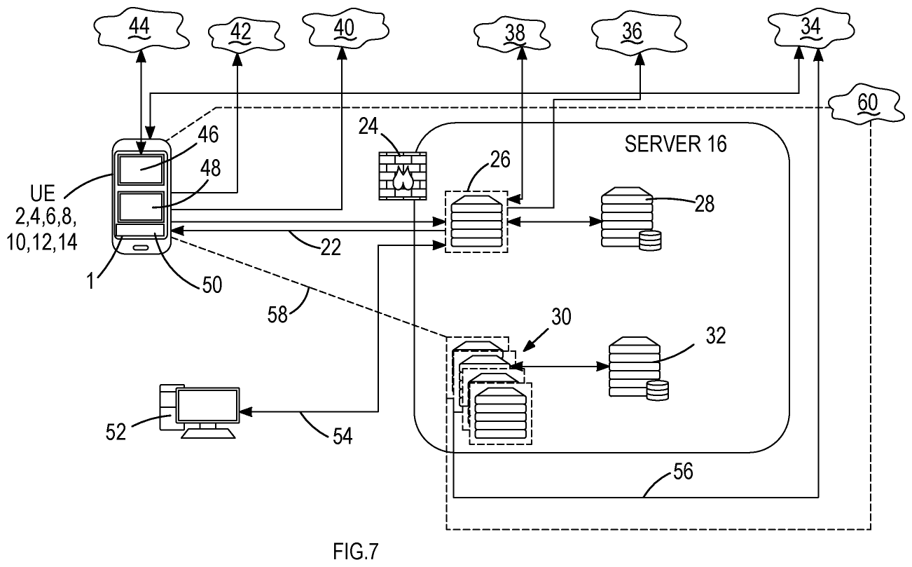

FIG. 7 presents a server 16 and UE architecture corresponding the system and methods described with reference to FIGS. 5 and 6.

The server 16 may comprise one or more servers hosted on a cloud-based platform, such as an Amazon Web Services (AWS) cloud-computing platform. Alternatively, the server 16 may be a private server specifically for use with the transport coordination system. The server 16 comprises a first API 26, such as a PHP-based API 26, which executes token authentication 22 when the UE 2, 4, 6, 8, 10, 12, 14 logs onto the system using the transport coordination application 1. In some examples the first API 26 is the main API which handles user data, meta trip data and user sessions. Interaction with the server 16 may be controlled by a firewall 24.

The server 16 further comprises a first database 28, such as an SQL database or more specifically a MySQL database, in communication with the first API 26. The first database can store user data such as user profiles 200, group profiles 400, trip meta-data, payment data, admin data and support data. The server 16 further comprises a second API 30, such as a Python-based API, in communication with the first API 26. The second API 30 can be in constant contact with the first API 26. In some examples, the second API 30 may be distributed across multiple servers. The second API 30 is responsible for real time location data; a Python API is appropriate for such a purpose in terms of speed and handling multiple sessions with users at a time. In some examples the first API 26 suited to onboarding users of the system and the second API 30 is suited to processing real time rides that are occurring. In some examples, the application 1 may be able to communicate with the Python API 30 by direct Python calls 58. The second API 30 is in communication with a second database 32, such as an SQL database or more specifically a PostgreSQL database. The second database 32 can store real-time location data and user location history. The second database 32 can be faster and allows for better processing of large amounts of real-time data. Versioning improves efficiency in the application and splits the workloads of the APIs; this allows for scaling for high numbers of users. The second API 30 communicates data and notifications 56 with the UE 2, 4, 6, 8, 10, 12, 14 by a cloud messaging service 34, such as a Firebase cloud messaging service. Such data and notifications can include the messages sent between the UEs and the server 16 as described with reference to FIGS. 1, 3, 5 and 6; these messages may be sent using the cloud messaging service via a data network such as a 4G or 5G network. In some examples, a Firebase real-time database 60 may be used. In some examples, the first API 26 may be in communication with a driver validation service 38, such as the DVLA, to check that users who act as driver's are suitably registered and licensed, with suitably registered and licensed vehicle.

The first API 26 may also be in communication with an SMS bulk service 36. In some examples, the SMS bulk service 36 may be used to communicate marketing communications to individual users or groups of users. These may include reward-based incentives or discounts for repeat users, or promotional discounts for groups of users. A logging service, such as a Talon.ONE service can be used log activities and milestones reached by users and assign rewards, defined by sets of rules.

The transport coordination application 1 is loaded on the UE 2, 4, 6, 8, 10, 12, 14. The transport coordination application 1 includes a mapping module 46, such as a MapBox SDK. The mapping module 46 is in communication with an external mapping service 44, such as a MapBox API. The application 1 can further include a data capture module 48, such as a MicroBlink SDK. The data capture module 48 is in communication with an external data capture service 42, such as a MicroBlink API. The data capture module 48 can be used to scan a user's driver's licence, to provide the information thereon as plain text. This is beneficial as it allows for a check that the licence has not been used before and that all drivers are unique and have a driving licence. This information can also be used to check for issues associated with the licence such as penalty points. The application 1 can further include an address capture module 50, such as a What3words module, to identify geographical coordinates of addresses entered to or received by the application 1. The address capture module 50 can be in communication with an external address capture service 40, such as a What3words API.

An administration dashboard 52 can be in communication with the server 16 to administer and control the system. The administration dashboard 52 can perform token authentication 54 with the first API 26 at the server 16 in order to access the server 16 for control purposes.

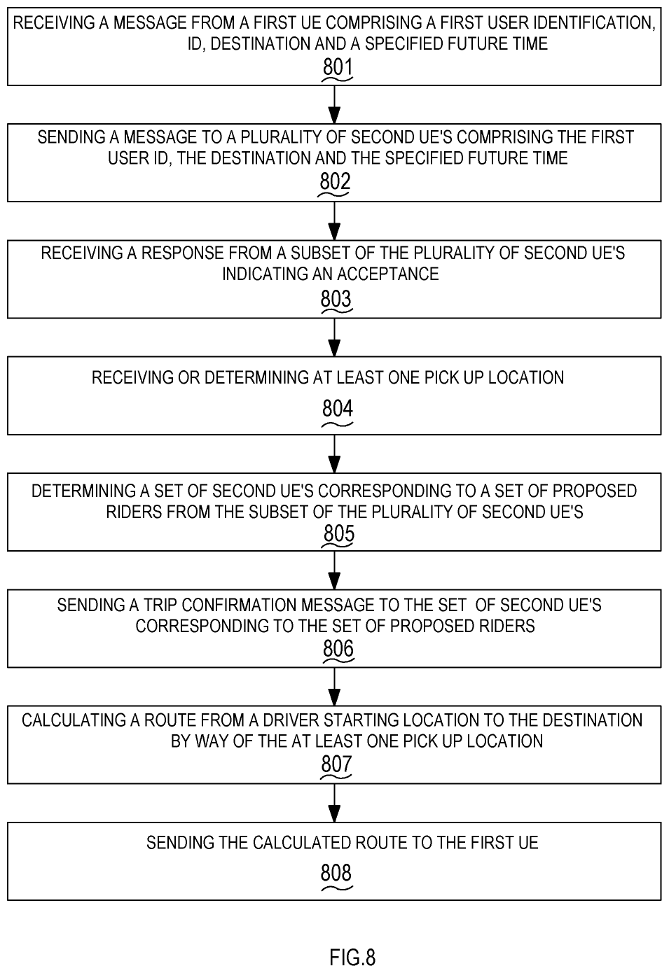

FIG. 8 shows a flow diagram of a process for connecting UEs to coordinate a transport request, in accordance with the previously described embodiments.

Step 801 comprises receiving a message from a first UE comprising a first user identification, ID, a destination and a specified future time.

Step 802 comprises sending a message to a plurality of second UEs comprising the first user ID, the destination and the specified future time.

Step 803 comprises receiving a response from a subset of the plurality of second UEs indicating an acceptance.

Step 804 comprises receiving or determining at least one pick up location.

Step 805 comprises determining a set of second UEs corresponding to a set of proposed riders from the subset of the plurality of second UEs.

Step 806 comprises sending a trip confirmation message to the set of second UEs corresponding to the set of proposed riders.

Step 807 comprises calculating a route from a driver starting location to the destination by way of the at least one pick up location.

Step 808 comprises sending the calculated route to the first UE.

In an example, the steps of FIG. 8 are executed at the server 16. In examples, the steps of FIG. 8 relate to the steps described with reference to FIGS. 5 and 6. The skilled person will readily understand that the steps of FIG. 8 can take place in any suitable order, and not only the order presented.

The processing steps described herein, particularly with reference to the steps performed by the UEs and server in FIGS. 1, 3, 5, 6, and 8 may be stored in a non-transitory computer-readable medium, or storage, associated with the UE or server. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that embodiments and examples in the foregoing description are not limiting; features of each embodiment and example may be incorporated into the other embodiments and examples as appropriate.

1. A computer-implemented method of connecting user equipments (UEs) to coordinate a transport request, the method comprising:
receiving at a server, a message from a first user equipment, UE, comprising a first user identification, ID, a destination and a specified future time;
sending, from the server, a message to a plurality of second UEs comprising the first user ID, the destination and the specified future time;
receiving, at the server, a response from a subset of the plurality of second UEs indicating an acceptance;
receiving or determining, at the server, at least one pick up location;
determining, at the server, a set of second UEs corresponding to a set of proposed riders from the subset of the plurality of second UEs;
sending, from the server, a trip confirmation message to the set of second UEs corresponding to the set of proposed riders;
calculating, at the server, a route from a driver starting location to the destination by way of the at least one pick up location; and
sending, from the server, the calculated route to the first UE.

2. The method of claim 1, further comprising:
sending, from the server, the calculated route to the set of second UEs corresponding to the set of proposed riders.

3. The method of claim 1, wherein the message received at the server from the first UE includes a number of available seats.

4. The method of claim 1, wherein the pick up location is received at the server from the first UE.

5. The method of claim 1, wherein a plurality of pick up locations are received from the set of second UEs corresponding to the set of proposed riders.

6. The method of claim 1, wherein the pick up location is determined at the server based on stored parameters related to the first UE and the set of second UEs corresponding to the set of proposed riders.

7. The method of claim 1, further comprising the step of receiving, at the server, a selection of the plurality of second UEs that are to be sent the message comprising the first user ID, the destination and the specified future time.

8. The method of claim 7, further comprising the step of sending, from the server, a list of available second UEs to the first UE for the first UE to make a selection.

9. The method of claim 8, further comprising the step of filtering, at the server, the list of available second UEs based on one or more parameters.

10. The method of claim 1, further comprising receiving, at the server, a response from a second UE of the plurality of second UEs indicating a refusal, and subsequently sending, from the server, a message to at least one further second UE comprising the first user ID, the destination and the specified future time.

11. The method of claim 1, further comprising the step of sending, from the server, before the trip confirmation message is sent, a message to the first UE confirming the set of proposed riders from the subset of the plurality of second UEs, and receiving, at the server, a message from the first UE rejecting at least one of the proposed riders.

12. The method of claim 1, further comprising sending, from the server, the position of the first UE to the set of second UEs corresponding to the set of proposed riders, and sending, from the server, to the first UE the positions of the second UEs in the set of second UEs corresponding to the set of proposed riders.

13. A server computer comprising one or more processors configured to:
receive a message from a first user equipment, UE, comprising a first user identification, ID, a destination and a specified future time;
identify a plurality of second UEs which are associated with the first UE;
send a message to the plurality of second UEs comprising the first user ID, the destination and the specified future time;
receive a response from a subset of the plurality of second UEs indicating an acceptance;
receive or determine, at the server, at least one pick up location;
determine a set of second UEs corresponding to a set of proposed riders from the subset of the plurality of second UEs;
send a trip confirmation message to the set of second UEs corresponding to the set of proposed riders;
calculate a route from a driver starting location to the destination by way of the at least one pick up location; and
send the calculated route to the first UE

14. A non-transitory computer readable medium comprising executable instructions which, when executed by a server, cause the server to carry out steps comprising:
receiving at a server, a message from a first user equipment, UE, comprising a first user identification, ID, a destination and a specified future time;
sending, from the server, a message to a plurality of second UEs comprising the first user ID, the destination and the specified future time;
receiving, at the server, a response from a subset of the plurality of second UEs indicating an acceptance;
receiving or determining, at the server, at least one pick up location;
determining, at the server, a set of second UEs corresponding to a set of proposed riders from the subset of the plurality of second UEs;
sending, from the server, a trip confirmation message to the set of second UEs corresponding to the set of proposed riders;
calculating, at the server, a route from a driver starting location to the destination by way of the at least one pick up location; and
sending, from the server, the calculated route to the first UE.
